(19) United States
(12) Patent Application Publication
(10) Pub. No.: US 2017/0334169 A1
(43) Pub. Date: Nov. 23, 2017

(54) Self-Adhesive Polymer Film Surface Protection System

(71) Applicant: Applied Polymer Solutions, LLC, Harrisburg, PA (US)

(72) Inventor: Jeffrey Heshler, Harrisburg, PA (US)

(21) Appl. No.: 15/599,011

(22) Filed: May 18, 2017

Related U.S. Application Data
(60) Provisional application No. 62/338,700, filed on May 19, 2016.

(51) Int. Cl. B32B 9/04; C09D 5/20; C09J 153/02; C09J 7/02

(52) U.S. Cl. CPC B32B 9/04; C09J 7/021; C09D 5/20; C09J 7/0207; C09J 7/0214; C09J 7/0217; C09J 153/025; B32B 2405/00; C08L 2205/03; B32B 2325/00; C09J 2453/00; C09J 2467/006

(57) ABSTRACT

Surface protection systems, methods of forming, and methods of applying are described. A surface protection system includes a damage resistant polymer film having a major surface and an adhesive deposited on the major surface of the damage resistant polymer film. The damage resistant polymer film has a thickness of about 8 mils to about 20 mils.

### CROSS-REFERENCE TO RELATED APPLICATION

The present application claims priority to U.S. Provisional Patent Application Ser. No. 62/338,700, filed May 19, 2016 and entitled “SELF-ADHESIVE POLYMER FILM WALL AND SURFACE PROTECTION SYSTEM,” the entire contents of which is incorporated herein by reference.

### BACKGROUND

### Field

The present specification generally relates to surface coverings and, more particularly, to self-adhesive polymer surface protection systems that are damage resistant.

### Technical Background

Currently, surface coverings, such as wall coverings, floor coverings, and/or the like, can be used for a variety of purposes, such as, for example, for decorative purposes and for protective purposes (e.g., protection from damage). Surface coverings that are used for protective purposes, such as impact protection, scratch protection, dent protection, scrape protection, smudge protection, markings, and/or or the like (e.g., to prevent damage to the surface upon which they are installed) are typically constructed of a material that is thick and therefore relatively heavy. Use of such a thick material makes the surface covering more noticeable to an average human observer, which may not be desirable. Use of such a thick material also requires the material to be manufactured in sheets instead of rolls, which require special handling and cannot be easily cut by an end user to suit certain desired dimensional aspects (e.g., to conform to a particular shape of surface upon which it is applied). In addition, due to the relatively heavy weight, such protective surface coverings must use mechanical securing devices, such as screws, bolts, nails, or the like to secure the surface coverings to the surface. Such mechanical securings are not aesthetically pleasing and cause damage to the surface, so the surface coverings are not removable without resulting in damage to the surface. Use of adhesives that do not damage the surface, while available for surface coverings that are used for decorative purposes, are generally not suitable for surface coverings that provide damage protection because such adhesives cannot support the thick and heavy surface coverings on the surface.

Accordingly, a need exists for surface coverings that provide damage protection, particularly from impacts, scratches, dents, abrasions, scrapes, smudges, marks and overall wear, but are constructed of a material that is sufficiently thin and lightweight such that the material can be rolled for being transported, cut to particular dimensions after manufacture, and such that an adhesive can be used to secure the surface coverings to the surface without resulting in damage to the surface if the surface coverings are subsequently removed.

### SUMMARY

In one embodiment, a surface protection system includes a damage resistant polyethylene terephthalate film comprising a first major surface and a second major surface, a hard coat deposited on the first major surface of the damage resistant polyethylene terephthalate film, a cap sheet contacting hard coat located on the first major surface of the damage resistant polyethylene terephthalate film, an adhesive deposited on the second major surface the damage resistant polyethylene terephthalate film, and a release liner covering the adhesive. The damage resistant polyethylene terephthalate film has a thickness of about 8 mils to about 20 mils. The surface protection system, when applied to a surface, withstands damage at a pencil hardness of 4H or greater to protect the surface.

In another embodiment, a surface protection system includes a damage resistant polymer film comprising a major surface and an adhesive deposited on the major surface of the damage resistant polymer film. The damage resistant polymer film has a thickness of about 8 mils to about 20 mils.

In yet another embodiment, a surface protection system includes a damage resistant polyethylene terephthalate film comprising a major surface and an adhesive deposited on the major surface of the damage resistant polyacrylic film. The damage resistant polyethylene terephthalate film has a thickness of about 8 mils to about 20 mils.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

FIG. 1 schematically depicts a cross-sectional view of a plurality of layers of an illustrative self-adhesive polymer film surface protection system according to one or more embodiments shown and described herein;

FIG. 2 schematically depicts an exploded perspective view of the plurality of layers of the illustrative self-adhesive polymer film surface protection system of FIG. 1;

FIG. 3 schematically depicts a cross-sectional view of a plurality of layers of an illustrative polymer film according to one or more embodiments shown and described herein;

FIG. 4 schematically depicts a perspective view of illustrative dimensional aspects of a self-adhesive polymer film surface protection system according to one or more embodiments shown and described herein;

FIG. 5 schematically depicts a perspective view of an illustrative roll embodiment of a self-adhesive polymer film surface protection system according to one or more embodiments shown and described herein;

FIG. 6 schematically depicts a perspective view of an illustrative self-adhesive polymer film surface protection system having indicia thereon according to one or more embodiments shown and described herein;

FIG. 7A schematically depicts a perspective view of an illustrative self-adhesive polymer film surface protection system applied to a surface according to one or more embodiments shown and described herein;

FIG. 7B schematically depicts a cross sectional view of the self-adhesive polymer film surface protection system and the surface of FIG. 7A when viewed along axis A-A of FIG. 7A;

FIG. 8 depicts a flow diagram of an illustrative method of forming a self-adhesive polymer film surface protection system according to one or more embodiments shown and described herein; and

FIG. 9 depicts a flow diagram of an illustrative method of applying a self-adhesive polymer film surface protection to a surface according to one or more embodiments shown and described herein.

### DETAILED DESCRIPTION

Referring generally to the figures, embodiments described herein are directed to a system for providing damage protection for surfaces, as well as methods for forming and applying such systems. The systems described herein generally include a polymer film having a hard coat and an adhesive backing that secures the polymer film to the surface without the need for mechanical retention components that damage the surface. In addition, the adhesive backing also allows the polymer film to be removed from the surface without damaging the surface.

While the systems described herein may generally be applied to any surface, the systems described herein may be particularly applied to surfaces that are susceptible to damage, such as floors, walls, ceilings, or the like, such as floors, walls, and ceilings located in corridors, lobbies, vestibules, bathrooms, dining areas, or the like. For example, many interior building walls are constructed of a drywall material (e.g., gypsum panels or the like) that can be easily damaged or marked if contacted by an object, thereby causing damage such as gouges, nicks, streaks, shoe marks, hand prints, scratches, holes, and/or the like in the surface thereof. As such, it may be desirable to cover such surfaces with a damage resistant covering that can absorb the damage and avoid causing damage to the surface thereunder. Illustrative locations containing surfaces where it may be desirable to implement the systems described herein include, but are not limited to, hotels, hospitals, medical buildings, office buildings, automobile dealerships, apartments and condominiums, schools, restaurants, convenience stores, retail stores, and the like.

Most of the commonly used surface coverings in the market today, such as wallpaper, paint, or the like, are primarily used for aesthetic purposes and provide little or no protection from damage such as impacts or the like. Certain surface coverings, such as surface coverings that employ a thin film resin, are primarily used for aesthetics and moisture resistance. In order to be sufficiently thin for aesthetic purposes, self-supporting purposes, and for stretchable purposes, such thin film resin surface coverings must be no more than 25 microns (0.98 mils) thick. As such, resins or the like having a thickness of less than 25 microns are generally not suitable for protecting a surface upon which it is installed from damage. Therefore, surface having such resin coverings can still be damaged when contacted with certain objects.

Other surface coverings that are thicker and more damage resistant, such as vinyl wall coverings or the like, may be thicker in size to provide sufficient damage protection. For example, some wall coverings may be 1016 microns (40 mils) to about 1905 microns (75 mils) thick. However, such wall coverings are generally not constructed of a clear material and are very noticeable once placed on the wall, which may not be aesthetically desirable. Moreover, such wall coverings do not have an adhesive material located on one surface thereof. Rather, a user must apply a mastic primer to the surface upon which the wall covering is to be installed, wait for a particular period of time for the primer to cure (e.g., 24 hours or more), apply a mastic compound to the surface, and then apply the wall covering over the mastic compound. Such an installation process is very time consuming, which may not be desirable to some users. Moreover, mastic compounds cannot be easily removed from the surface without damaging the surface, if a user desires to remove the wall covering at a later time.

Other surface coverings, such as polyvinyl chloride (PVC) based coverings or the like, may provide protection from damage when installed on a surface. However, such surface coverings, in order to provide sufficient damage protection, are generally thicker than the various other surface coverings described hereinabove. Such a thick material results in a wall covering that is noticeable to an average observer when the wall covering is placed on a surface, even in instances when the wall covering is constructed of a clear material. Moreover, such wall coverings are either too heavy to be applied with an adhesive or require relatively small tiles to be applied with an adhesive (e.g., a chair rail sized material). As such, the wall coverings are mechanically fastened to the wall with screws, nails, bolts, and/or the like. Use of such mechanical fasteners results in a covered surface that is damaged (i.e., the mechanical fastener has to be inserted into the surface, causing a hole if it is removed), and not aesthetically pleasing (i.e., the mechanical fasteners may be visible to the average observer).

The present systems overcome all of the deficiencies mentioned above by using a self-adhesive polymer film with a hardcoat layer that is a sufficient thickness so as to allow for damage resistance, but not so heavy that self-adhesive polymer film requires mechanical fasteners, a mastic compound, or the like to be applied to the surface prior to application of the film. Moreover, the polymer films described herein can be constructed in various thicknesses, sizes, quantities, colors, and designs. In some embodiments, the polymer films described herein may be clear such that they are not as noticeable when applied to a surface. In some embodiments, the polymer films described herein may have a matte or a gloss finish. In some embodiments, the polymer films described herein may be impregnated or coated with an antimicrobial compound and/or manufactured with chemical resistant properties such that the polymer films may be desirable for certain applications (e.g., used for surface protection in places that may be susceptible to disease propagation, such as daycare facilities, schools, nursing homes, hospitals, medical buildings, pharmacies, and/or the like. In some embodiments, the polymer films described herein may provide protection from dirt, grime, fingerprints, graffiti, and/or the like. Moreover, the polymer films described herein can be easily molded or cut to correspond to a variety of different shaped and sized surfaces.

As used herein, the term “damage resistant” refers to systems or the like that are resistant to any external forces that would otherwise cause damage to a surface upon which the polymer films are applied. Illustrative examples of damage include, but are not limited to, impact damage, scratches, dents, abrasions, scrapes, smudges, marks, graffiti, and general overall wear. As such, the damage resistant polymer films provide protection from impact damage, scratches, dents, abrasions, scrapes, smudges, marks, graffiti, and general wear to a surface upon which the polymer films are applied. As a result, the surface underneath the polymer films applied thereon remain substantially free of scratches, dents, abrasions, scrapes smudges, marks, graffiti, general wear, and/or the like. It should be understood that “damage resistant” is used in the context of resisting damage to the surface underneath the polymer film (when applied) and/or the polymer film itself That is, in some embodiments, the damage resistant properties of the polymer film may prevent the surface upon which it is installed from being damaged, but not necessarily the polymer film itself In other embodiments, the damage resistant properties of the polymer film may prevent both the surface upon which it is installed and the polymer film itself from being damaged.

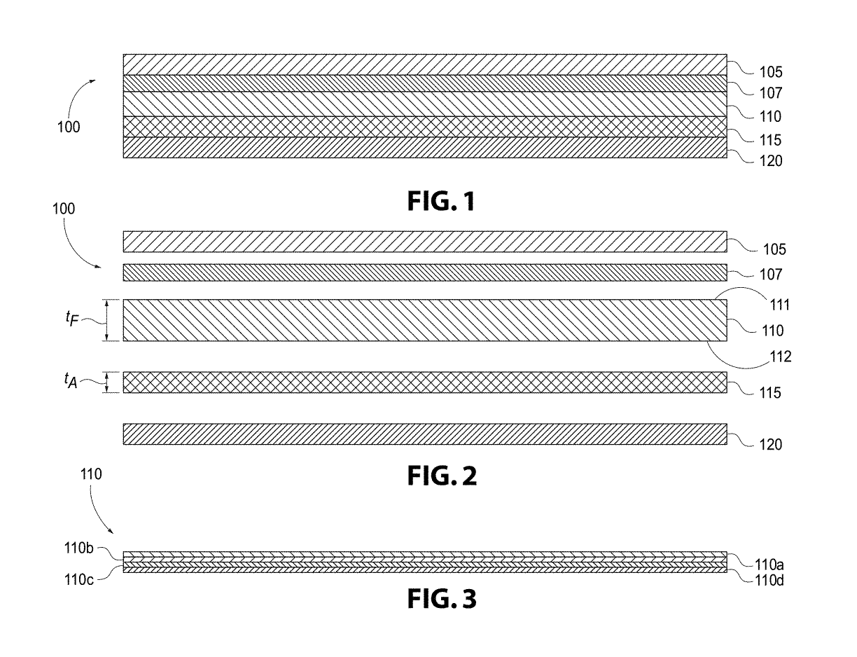

FIG. 1 depicts a cross-sectional view of an illustrative surface protection system, generally designated 100, according to one or more embodiments. As shown in FIG. 1, the surface protection system 100 includes a polymer film 110 with an adhesive 115 applied thereto, as well as a release liner 120 to protect the adhesive 115 before the surface protection system 100 is applied to a surface. In some embodiments, the surface protection system 100 may further include a hardcoat layer 107. In some embodiments, the surface protection system 100 may further include a cap sheet 105.

As depicted in FIG. 2, the polymer film 110 has a first major surface 111 and a second major surface 112 opposite the first major surface 111. In embodiments where the surface protection system 100 includes a hardcoat layer 107, the hardcoat layer 107 may be deposited on the first major surface 111 of the polymer film 110. In embodiments where the surface protection system 100 includes a cap sheet 105, the cap sheet may be coupled to the hardcoat layer 107 or, if no hardcoat layer 107 exists, to the first major surface 111 of the polymer film 110. As will be described in greater detail herein, the adhesive 115 may be applied to the second major surface 112 of the polymer film 110, and the release liner 120 may be applied over the adhesive 115.

The polymer film 110 is generally a damage resistant polymer film. As such, the polymer film 110 may generally be constructed of a polymer material that has damage resistant properties. As used herein, the term “polymer” refers to a linkage of monomers, particularly polymers described in greater detail herein. A polymer may include, but is not limited to, a homopolymer, a heteropolymer, a copolymer, a hydrophobic polymer, a hydrophilic polymer, or any combination thereof. A “hydrophobic polymer” refers to a polymer that does not absorb an appreciable amount of water or an aqueous solution. Hydrophobic polymers may be particularly used in embodiments where the polymer film 110 acts as a moisture barrier for the surface upon which it is applied. A “homopolymer” refers to a polymer comprising a single type of monomer, such as, for example, hydroxyethylmethyl acrylate. A “heteropolymer” refers to a polymer comprising more than one type of monomer, such as, for example, hydroxyethylmethyl acrylate and methylacrylic acid. A “copolymer” refers to two different polymers that are linked together to make a polymer chain.

In some embodiments, the polymer film 110 may be constructed of a material that is substantially transparent and/or clear such that an observer can see through the polymer film 110 when installed on a surface. As used herein, “transparent” refers to a substantial portion of visible light transmitted through the polymer film 110, such as greater than or equal to 90% of incident light, greater than or equal to about 90% of incident light, greater than or equal to about 98% of incident light, or greater than or equal to about 99% incident light. In other embodiments, the polymer film 110 may be constructed of an opaque material or a partially opaque material, particularly in embodiments where a pattern, color, or the like is printed on the polymer film 110, as described in greater detail herein. As used herein, “opaque” refers to a substantial portion of visible light reflected or absorbed by the polymer film 110, such as greater than or equal to about 90% of incident light, greater than or equal to about 90% of incident light, greater than or equal to about 98% of incident light, or greater than or equal to about 99% incident light. As used herein, “partially opaque” refers to a material having a combination of transparent and opaque properties.

In some embodiments, the polymer film 110 may be constructed of a material that provides the appearance of having a glossy surface. That is, the polymer film 110 may possess a particular gloss value (i.e., surface reflectance). This gloss value can be determined by measuring the specular gloss of the coating at 60° with a gloss meter. A standard (ASTM) test method for specular gloss is defined in ASTM D 523-89. As used herein, the term “glossy” generally refers to a 60° gloss value of about 90 or greater. As such, the 60° gloss value of the polymer film 110, when glossy, can be about 90 or greater, about 130 or greater, about 150 or greater, in a range from about 130 to about 200, or in a range from about 160 to about 190.

In some embodiments, the polymer film 110 may be constructed of a material that provides the appearance of having a matte surface. As used herein, the term “matte” generally refers to a 60° gloss value of less than about 90. It should be understood that in some embodiments, portions of the polymer film 110 may have the appearance of having a matte surface and other portions of the polymer film 110 may have the appearance of having a glossy surface.

Illustrative examples of materials that may be used for the polymer film include, but are not limited to, polyurethane, polyester, polypropylene, polyvinyl, polyacrylic, polycarbonate, and a combination of any of the foregoing.

In some embodiments, the polymer film 110 may be constructed of a polyethylene terephthalate (polyester or PET) material. That is, the polymer film 110 may be a polyethylene terephthalate film. Polyethylene terephthalate film, together with a hardcoat layer as described herein, is durable and features abrasion and scratch resistance. PET film is thermally stable, exhibits high tensile properties, exhibits high tear properties, and exhibits impact strength properties. The PET film remains tough and flexible once applied, provides vapor resistance, and is unaffected by oils, greases, and volatile aromatics.

Polyethylene terephthalate material may generally be produced by the polymerization of ethylene glycol and terephthalic acid. When heated together under the influence of chemical catalysts, ethylene glycol and terephthalic acid produce PET in the form of molten, viscous mass that can be spun directly to fibers or solidified for later processing as a plastic. The presence of a large aromatic ring in the PET repeating units gives the polymer notable stiffness and strength, especially when the polymer chains are aligned with one another in an orderly arrangement by stretching. At a slightly higher molecular weight PET is made into a high-strength plastic that can be shaped various methods employed with other thermoplastics.

In some embodiments, the polymer film 110 may be a monolayer of polymer material. That is, the polymer film 110 may comprise a single layer of polymer material. Monolayers of polyethylene terephthalate material should generally be understood and are not described in further detail herein.

In other embodiments, the polymer film 110 may include a plurality of layers of polymer material, as shown, for example, in FIG. 3. More specifically, FIG. 3 depicts a polymer film 110 including a first layer 110a, a second layer 110b, a third layer 110c, and a fourth layer 110d. While FIG. 3 depicts four layers, it should be understood that such a number of layers is merely illustrative and greater or fewer layers could also be used without departing from the scope of the present disclosure. The plurality of layers 110a, 110b, 110c, 110d may be bonded to one another via an adhesive, a binding agent, and/or the like. In some embodiments, each of the plurality of layers of polymer material may be constructed of a material that is different from another one of the plurality of layers of polymer material. For example, the first layer 110a may be formed from a first material (e.g., a polyacrylic material as described herein), the second layer 110b may be formed from a second material that is different from the first material (e.g., polyurethane), the third layer 110c may be formed from a third material that may be different from the first material and/or the second material, and the fourth layer 110d may be formed from a fourth material that may be different from the first material, the second material, and/or the third material. In other embodiments, each of the plurality of layers may include the same material. For example, each of the first layer 110a, the second layer 110b, the third layer 110c, and the fourth layer 110d may be formed from the same polyacrylic material.

Referring again to FIG. 2, in some embodiments, the polymer film 110 (including monolayer polymer films and polymer films including a plurality of layers) may be embedded with various components to affect the properties of the polymer film 110. In a nonlimiting example, one or more of the layers of the polymer film 110 may be embedded with one or more pigments such that the resulting polymer film 110 is colored and/or contains a particular opacity. Pigments may be embedded into the film via masterbatches. It should be understood that a masterbatch includes concentrated pigments dispersed into a polymer carrier resin. During molding, the masterbatch is mixed with the resin as it is fed into a press at a predefined ratio to achieve a particular color. In another nonlimiting example, one or more of the layers of the polymer film 110 may be embedded with antimicrobial agents to prevent microbes from adhering to the polymer film 110 and providing the polymer film 110 with antimicrobial properties. For example, an antimicrobial hardcoat may be applied to at least one of the surfaces of the polymer film 110 and may subsequently be UV cured. The antimicrobial hardcoat may incorporate nanosilver additives, which are evenly distributed throughout the hardcoat coating. It should be understood that the nanosilver additives are additives that contain silver nanoparticles (clusters of silver atoms). Such nanosilver additives may disrupt bacterial enzymes, which inhibits the growth of bacteria.

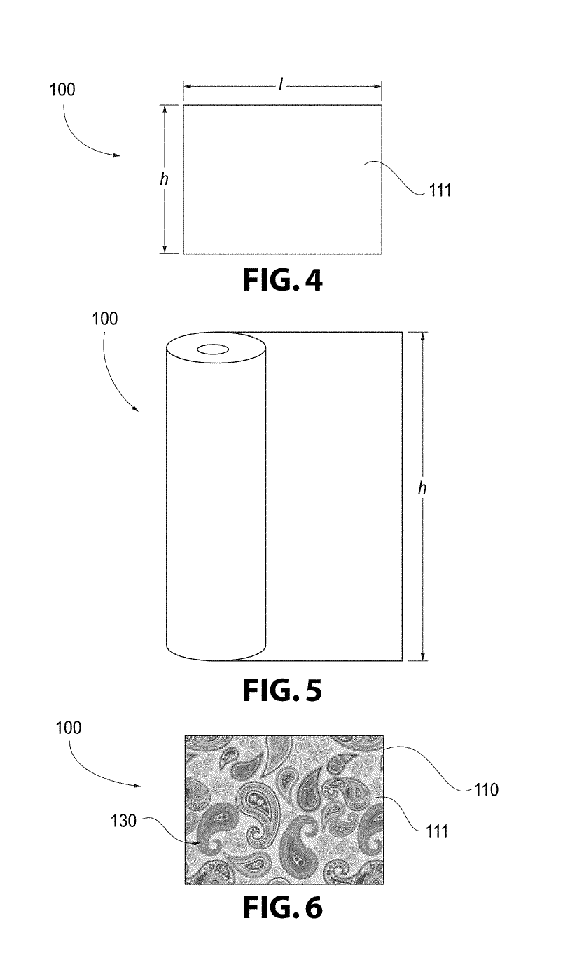

The dimensional aspects of the polymer film 110 (as well as the system 100 in general) are not limited by the present disclosure. That is, the polymer film 110 may be constructed in any shape and/or size. For example, as shown in FIG. 4, in some embodiments, the polymer film 110 may be constructed as a rectangular sheet or tile. The polymer film 110, when viewed towards the first major surface 111, may have a height h and a length l. In some embodiments, the height h may be about 1 inch (about 2.54 cm) to about 500 inches (about 1270 cm), including about 1 inch, about 6 inches, about 12 inches, about 24 inches, about 36 inches, about 48 inches, about 60 inches, about 72 inches, about 84 inches, about 96 inches, about 100 inches, about 200 inches, about 300 inches, about 400 inches, about 500 inches, or any value or range between any two of these ranges (including endpoints). In some embodiments, the length l may be about 1 inch (about 2.54 cm) to about 500 inches (about 1270 cm), including about 1 inch, about 6 inches, about 12 inches, about 24 inches, about 36 inches, about 48 inches, about 60 inches, about 72 inches, about 84 inches, about 96 inches, about 100 inches, about 200 inches, about 300 inches, about 400 inches, about 500 inches, or any value or range between any two of these ranges (including endpoints). In a particular embodiment, the polymer film 110 may be a sheet having a length l of about 48 inches (about 121.92 cm) and a height h of about 36 inches (about 91.44 cm). In other embodiments, the polymer film 110 may be a tile having a length l of about 18 inches (about 45.72 cm) and a height h of about 14 inches (about 35.56 cm). In other embodiments, the polymer film 110 may be a tile having a length l of about 12 inches (about 30.48 cm) and a height h of about 12 inches (about 30.48 cm). Other dimensional aspects (including dimensions less than 1 inch and/or greater than 500 inches) are also contemplated.

Referring again to FIG. 2, the polymer film 110 may have a thickness t_{F}, where the thickness t_{F} is an average distance between the first major surface 111 and the second major surface 112 of the polymer film 110. The thickness t_{F} of the polymer film 110 is not limited by the present disclosure, and may generally be any thickness, particularly a thickness that is sufficient to withstand damage as described herein. In some embodiments, the thickness t_{F} may be based on the number of layers of polymer material contained within the polymer film 110, as described in greater detail herein.

Illustrative examples of the thickness t_{F} may include, but are not limited to, from about 8 mils (about 203.2 microns) to about 20 mils (about 508 microns), including about 8 mils (about 203.2 microns), about 9 mils (about 228.6 microns), about 10 mils (about 254 microns), about 11 mils (about 279.4 microns), about 12 mils (about 304.8 microns), about 13 mils (about 330.2 microns), about 14 mils (about 355.6 microns), about 15 mils (about 381 microns), about 16 mils (about 406.4 microns), about 17 mils (about 431.8 microns), about 18 mils (about 457.2 microns), about 19 mils (about 482.6 microns), about 20 mils (about 508 microns), or any value or range between any two of these values (including endpoints). In a particular embodiment, the thickness t_{F} of the polymer film 110 may be about 10 mils (about 254 microns).

It should be understood that thicknesses less than about 8 mils (about 203.2 microns) will not allow the polymer film 110 to provide sufficient damage resistance as described herein. Thicknesses less than about 8 mils (203.2 microns) may result in the surfaces under the polymer film becoming damaged due to impacts, scratches, dents, abrasion, smudges, marks, general overall wear, and/or the like. It should further be understood that the thickness t_{F} of the polymer film 110 may depend on the type of material that is used for the polymer film 110. That is, certain materials may have greater damage resistant properties than other materials (e.g., be more impact resistant), and thus may be constructed at a lesser thickness.

The polymer film 110 may be constructed such that it exhibits a particular damage resistance when various commonly used tests are applied to the polymer film 110. One illustrative example of a commonly used test for damage is the pencil hardness test. As such a test is commonly understood, it is not described in greater detail herein. The polymer film 110 (and thus the system 100 in general) may exhibit damage resistance of at least 4H when undergoing the pencil hardness test. Another illustrative example of a commonly used test for damage are various tests for scuffing, abrasion, and/or the like, such as, for example, the Sutherland Rub Test and ASTM D5264. Such tests for scuffing and abrasion are commonly understood and are not described in greater detail herein. The polymer film 110 (and thus the system 100 in general) may exhibit scuff and/or abrasion resistance to at least #0000 steel wool. Other illustrative examples of commonly used tests for damage are a chemical resistance test and/or a cleaning chemicals test, both of which are commonly understood and are not described in greater detail herein. The polymer film 110 (and thus the system 100 in general) may exhibit a resistance to household chemicals, including household glass cleaners. That is, the polymer film 110 may not be damaged (e.g., warped, clouded, scratched, scuffed, etc.) when household chemicals are applied thereto.

Still referring to FIG. 2, the hardcoat layer 107 may be any commonly manufactured hardcoat material, such as, for example, CleanView/ANR Polyester (TEKRA, A Division of EIS, Inc., New Berlin, Wis.). In various embodiments, the hardcoat layer 107 may be a cross linked polymer coating that has a thickness of less than about 1 mil. The cross linking of the polymer coating may allow for increased resistance properties to damage such as, for example, scratches, scuffs, and chemical application. In some embodiments, the material used for the hardcoat layer 107 may be integrated with various materials, including, but not limited to, inorganic SiOx or AlOx, which are materials that are added between about 0.01% by weight to about 10% by weight to increase the abrasion/scratch resistance. Other materials that may be integrated with the material used for the hardcoat layer 107 may include, but are not limited to, anti-microbial materials such as silver-based antimicrobials that are added at about 0.01% by weight to about 5% by weight to provide an antimicrobial effect. Yet other materials that may be integrated with the material used for the hardcoat layer 107 may include, but are not limited to, fluorinated materials including acrylates and fluorines added at about 0.01% by weight to about 15% by weight to reduce the coefficient of friction on the surface of the hardcoat layer 107. These materials also create a oleophobic/hydrophobic coating that adds in the prevention of water or oil from penetrating the surface of the hardcoat layer 107. The hardcoat layer may be water based, solvent based, or 100% solids. In embodiments where the hardcoat layer 107 is a 100% solids hardcoat layer 107, the hardcoat layer 107 may be considered to be UV curable. Such a 100% solids hardcoat layer 107 may be used for polyester based products, such as the polymer film 110 in some embodiments.

A non-limiting example of an illustrative polymer film 110 with hardcoat layer 107 deposited on the first major surface 111 thereof may be MELINEX® 461 (TEKRA, A Division of EIS, Inc., New Berlin, Wis.). Particular details regarding the properties of such a polymer film 110 with a hardcoat layer 107 deposited on the first major surface 111 thereof is shown in Table 1 below:

TABLE 1
Typical Properties
Available Thickness [Gauge]
200; 300; 400; 500; 700; 1000

| | | | | |
|---|---|---|---|---|
| Property | Thickness | Value | Units | Test |

OPTICAL

| | | | | |
|---|---|---|---|---|
| Haze | 200-300 | 0.4 | % | ASTM D1003 |
| Haze | 400-500 | 0.6 | % | ASTM D1003 |
| Haze | 700 | 0.8 | % | ASTM D1003 |
| Haze | 1000 | 1.2 | % | ASTM D1003 |
| Total Light | 200-1000 | 90 | % | ASTM D1003 |
| Transmission (TLT) | | | | |

PHYSICAL

| | | | | |
|---|---|---|---|---|
| C.O.F. (dynamic) A-B | 200-400 | 0.40 | | ASTM D1894 |
| C.O.F. (dynamic) A-B | 500-1000 | 0.30 | | ASTM D1894 |
| Elongation at Break | 200-1000 | 160 | % | ASTM D882 |
| MD | | | | |
| Elongation at Break | 200-1000 | 85 | % | ASTM D882 |
| TD | | | | |
| F5-MD | 200-1000 | 14,000 | psi | ASTM D882A |
| F5-TD | 200-1000 | 14,000 | psi | ASTM D882A |
| Tensile Strength | 200-1000 | 25,000 | psi | ASTM D882A |
| MD (break) | | | | |
| Tensile Strength | 200-400 | 35,000 | psi | ASTM D882A |
| TD (break) | | | | |
| Tensile Strength | 500-700 | 32,000 | psi | ASTM D882A |
| TD (break) | | | | |
| Tensile Strength | 1000 | 28,000 | psi | ASTM D882A |
| TD (break) | | | | |

THERMAL

| | | | | |
|---|---|---|---|---|
| Shrinkage MD (190° C.) | 200-1000 | 2.5 | % | Unrestrained |
| | | | | @ 190° C./5 |
| | | | | min |
| Shrinkage TD (190° C.) | 200-1000 | 1.0 | % | Unrestrained |
| | | | | @ 190° C./5 |
| | | | | min |

Still referring to FIG. 2, the adhesive 115 may be deposited on the second major surface 112 of the polymer film 110. The adhesive 115 generally functions to adhere the polymer film 110 to a surface. In some embodiments, the adhesive 115 may be a pressure-sensitive adhesive. That is, the adhesive 115 may form a bond between the polymer film 110 and the surface upon which the polymer film 110 is applied when pressure is applied to the polymer film 110, the adhesive 115, and/or the surface. It should be understood that pressure-sensitive adhesives may allow the polymer film 110 to be bonded to the surface without the need for a solvent, water, heat, or the like to activate the adhesive. In some embodiments, the pressure-sensitive adhesive may be a hot melt pressure-sensitive adhesive. In some embodiments, a pressure-sensitive adhesive may include an elastomer compounded with a tackifier, such as an acrylic elastomer compounded with a rosin ester. In some embodiments, a pressure-sensitive adhesive may include butyl rubber, natural rubber, silicone rubber, a nitrile, ethylene-vinyl acetate (EVA), a silicate resin, and the like, as well as combinations thereof. In some embodiments, a pressure sensitive adhesive may include a styrene block copolymer (SBC). In some embodiments, the pressure sensitive adhesive may include a resin such as coumarone-indene, α-methyl styrene, vinyl toluene, aromatic hydrocarbons, aliphatic olefins, rosin esters, polyterpenes, terpene phenolics, and the like, as well as combinations thereof. In some embodiments, a pressure-sensitive adhesive may include butyl acrylate, 2-ethyl hexyl acrylate, ethyl methacrylate, iso-octyl acrylate, and the like, as well as combinations thereof. In some embodiments, the pressure sensitive adhesive may have a glass-transition (Tg) temperature below an ambient temperature (e.g., less than about 20° C.) to achieve a dry tacky film. Some pressure-sensitive adhesives may have a glass transition temperature between about −20° C. and about −80° C.

In other embodiments, the adhesive 115 may not be pressure sensitive, but rather may be activated by heat, water, a solvent, and/or the like to bond the polymer film to the surface. Examples of adhesives that are activated by heat, water, a solvent, and/or the like should generally be understood and are not described in greater detail herein.

The adhesive 115 may have any thickness t_{A}. In some embodiments, the thickness t_{A} of the adhesive 115 may be dependent on a desired level of adhesion, to be particularly used for certain surfaces, and/or the like. Illustrative thicknesses include, but are not limited to, from about 0.5 mils (about 12.7 microns) to about 5 mils (about 127 microns), including about 0.5 mils, about 1 mil, about 1.5 mils, about 2 mils, about 2.5 mils, about 3 mils, about 3.5 mils, about 4 mils, about 4.5 mils, about 5 mils, or any value or range between any two of these values (including endpoints).

To avoid accidental adhesion of the adhesive 115 to objects other than a desired surface, the release liner 120 may be located over the adhesive 115 such that the adhesive is sandwiched between the release liner 120 and the polymer film 110. The release liner 120 is generally a disposable layer that is peelable away from the adhesive 115 and the polymer film 110 when the system 100 is installed on a surface, as described in greater detail herein. The release liner 120 may be made of any material that is capable of being temporarily bonded to the adhesive 115, but can later be removed without damaging the adhesive 115 or diminishing the adhesive properties of the adhesive 115. Nonlimiting examples of materials used for the release liner 120 include paper and polymeric film.

The adhesive 115 may exhibit certain adhesive and/or cohesive properties to ensure proper application of the system 100 as described herein. For example, when undergoing a 180° Peel Adhesion test using a Pressure Sensitive Tape Council (PSTC) standard test (such as PSTC-101A), the adhesive 115 may exhibit a 15 minute dwell (OLI) of about 25 and/or a 24 hour dwell (OLI) of about 44. In another example, when undergoing a shear adhesion test using a PSTC standard test (such as PSTC-107 (SS)), a 1 inch by 1 inch square at 500 grams exhibits a hold of at least about 100 hours.

In some embodiments, the adhesive 115 may be particularly suited for adhering the polymer film 110 in particular ambient conditions, such as an application temperature range of about 60° F. to about 100° F., including any value or range between both of these values (including endpoints). That is, the adhesive 115 may be applied to the polymer film 110 and/or a surface at temperatures of about 60° F. to about 100° F. The adhesive 115 may also exhibit a service temperature range of about 40° F. to about 250°, including any value or range between both of these values (including endpoints). That is, the adhesive 115 may hold the polymer film 110 to a surface at temperatures of about 60° F. to about 100° F.

In some embodiments, the system 100 may further include a cap sheet 105. In embodiments including a hardcoat layer 107, the cap sheet 105 may be disposed on the hardcoat layer 107. In other embodiments, the cap sheet 105 disposed on the first major surface 111 of the polymer film 110. The cap sheet 105 may generally be a layer of disposable material that serves to protect the first major surface 111 and/or the hardcoat layer 107 from damage. For example, the cap sheet 105 may protect the first major surface 111 and/or the hardcoat layer 107 of the polymer film 110 from being damaged during manufacture, transport, and/or the like. Thus, the cap sheet 105 may be removed during or after manufacture, after transport, or before installation of the polymer film 110 on the surface. Similar to the release liner 120, nonlimiting examples of materials used for the cap sheet 105 may include paper and polymeric film.

As previously described herein, the system 100 may be constructed in a variety of different sizes. For example, the system 100 may be constructed as sheets, tiles, or the like. In some embodiments, instead of a sheet or a tile, the system 100 may be manufactured as a roll of material, as shown in FIG. 5. As such, the system 100 may have a height h as described above, but may have a length that is greater than the lengths described hereinabove. As such, a user may cut a sheet having a desired length from the roll.

In some embodiments, the system 100 may be constructed such that a pattern, an image, text, or the like is placed on the first major surface 111 of the polymer film 110. For example, as shown in FIG. 6, indicia 130 may be applied to the first major surface 111 of the polymer film 110. The indicia 130 is not limited by this disclosure and may generally be any indicia, including patterns, images, text, and/or the like. The indicia 130 may be applied to the first major surface 111 in any manner now known or later developed. For example, the indicia 130 may be printed on the first major surface 111 (e.g., via ink deposition or the like), may be drawn onto the first major surface 111, may be a substrate that is attached or affixed to the first major surface 111 (e.g., the indicia 130 may be wallpaper or the like that is applied to the first major surface 111), may be impregnated within the first major surface 111 (e.g., impregnation of pigments within the polymer film 110 as described herein), and/or the like.

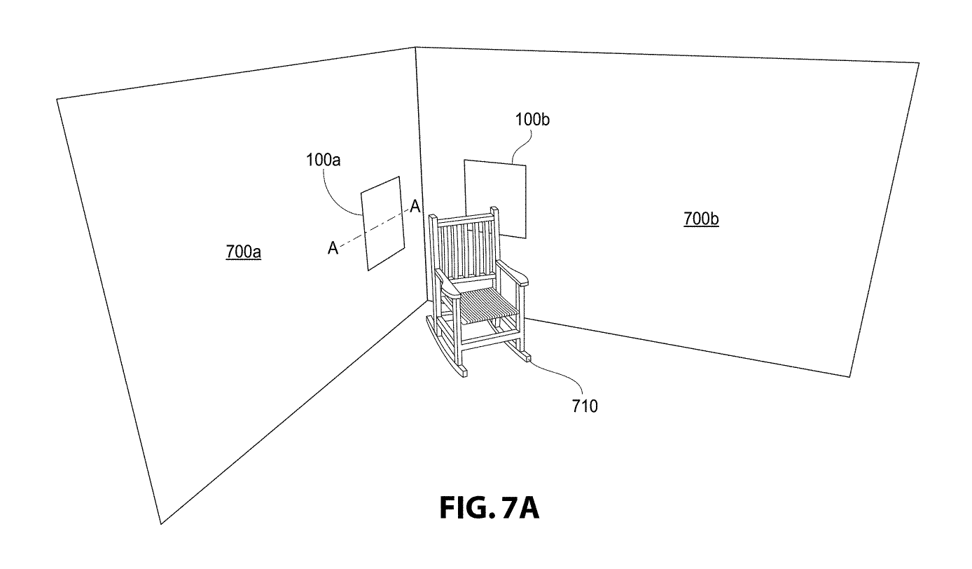

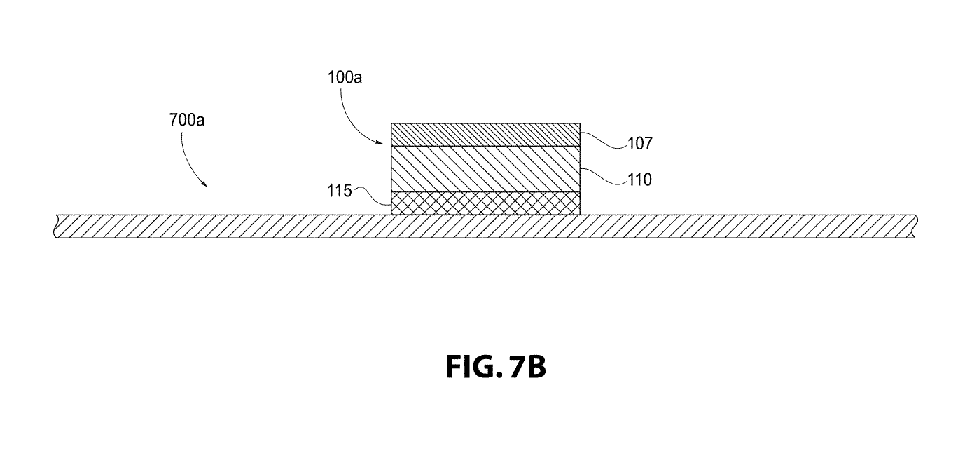

Referring now to FIG. 7A, the system 100a/100b, when applied to a corresponding surface 700a/700b (e.g., a wall), may protect the corresponding surface 700a/700b from damage thereto. More specifically, as shown in FIG. 7A, a rocking chair 710 may cause damage to ordinary drywall walls when the backwards rocking motion of the rocking chair 710 can cause portions of the rocking chair 710 to contact the drywall and poke a hole in the drywall, scratch the drywall, dent the drywall, mar the drywall, etc. However, with the system 100a/100b appropriately installed in areas where contact between the surface 700a/700b and the rocking chair 710 is possible, the system 100a/100b may absorb the force of the impact from the rocking chair 710, thereby avoiding damage to the respective surface 700a/700b thereunder.

FIG. 7B depicts a cross sectional view of the system 100a deposited on the surface 700a when viewed along axis A-A of FIG. 7A. As shown in FIG. 7B, the adhesive 115 is located between the surface 700a and the polymer film 110 to adhere the polymer film 110 to the surface 700a, as described herein. As also indicated in FIG. 7B, the release liner has been disposed prior to application of the adhesive 115 and the polymer film 110 to the surface 700a so as to expose the adhesive 115 to the surface 700a, as described herein.

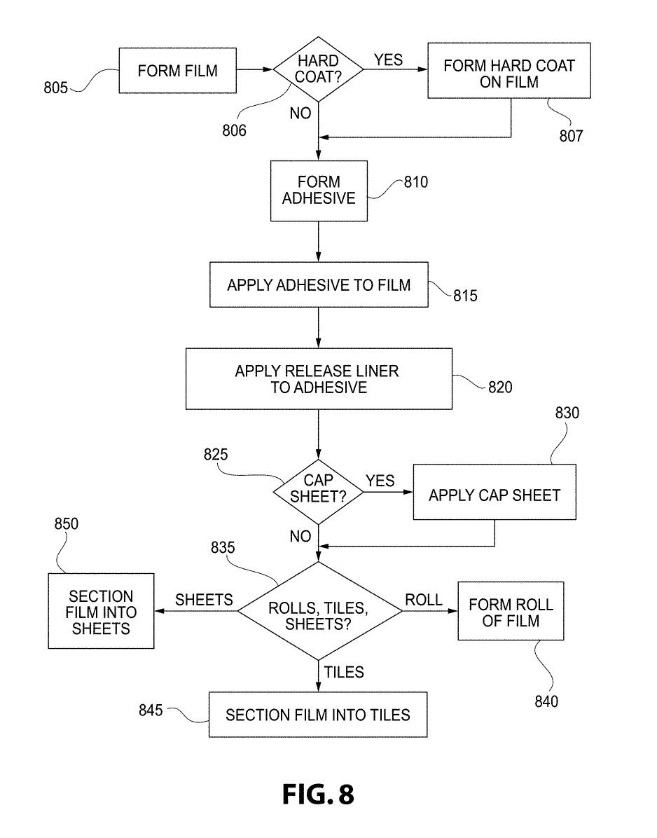

FIG. 8 depicts a flow diagram of an illustrative method of forming the system described herein according to one or more embodiments. At step 805 the polymer film may be formed. Forming the polymer film includes, for example, extruding molten polyethylene (PET) polymer onto a chill roll drum to form a film. This film then is biaxially oriented by being stretched first in a machine direction (MD) and then in a transverse direction (TD). The orientation is accomplished by passing the film over rollers that run at increasingly faster speeds (MD orientation), then fed into a tenter frame, where it is pulled at right angles (TD orientation). This stretching rearranges the PET molecules into an orderly structure to substantially improve the film's mechanical properties, as described herein. The film is heat set for stability purposes. The film will not shrink again until/unless exposed to its original heat-set temperature.

At step 806, a determination may be made as to whether a hardcoat layer is to be applied to the polymer film. If not, the process may proceed to step 810, as described hereinbelow. If a hardcoat layer is to be applied, the hard coat may be formed on the film at step 807. The hardcoat layer may be applied to the polymer film using a low coating deposition method. In some embodiments, the hardcoat layer may be coated on the polymer film using a reverse gravure coating head. Then the hardcoat material may be UV cured using high energy output bulbs (e.g., 200-600 W/cm² bulbs). The line speed and exposure time/dosage of the UV lights on the hardcoat material may drive the overall degree of crosslinking and subsequent resistance properties, as described in greater detail herein.

At step 810, the pressure-sensitive adhesive is formed. Pressure-sensitive adhesives may be manufactured with either a liquid carrier or in a 100% solid form. Liquid pressure sensitive adhesives are coated on a support and evaporating the organic solvent or water carrier, such as, for example, in a hot air dryer. The dry adhesive may be further heated to initiate a cross-linking reaction to increase molecular weight. 100% solid pressure sensitive adhesives may be low viscosity polymers that are coated and then reacted with radiation to increase molecular weight and form the adhesive; or they may be high-viscosity materials that are heated to reduce viscosity enough to allow coating, and then cooled to their final form.

At step 815, the adhesive is applied to the second major surface of the polymer film. In some embodiments, the liquid adhesive may be directly coated to the polymer film 110 via a coating/casting process. The liquid adhesive material may then be dried (e.g., solvent or water based adhesives), cured (e.g., via UV cure of solvent-free adhesives), or cooled (e.g., hot melt adhesives) to obtain the tacky adhesive performance. The equipment used to coat/cast the adhesive material may be equipment used for processes such as, but not limited to, slot die processes, reverse roll processes, knife over roll processes, gravure processes, reverse gravure processes, and/or the like. A particular process may be used based on the viscosity of the adhesive material as well as the coat weight desired to achieve the desired adhesive performance.

At step 820, the release liner is applied to the polymer film. Application of the release liner may include contacting the adhesive and the release liner to form a temporary bond between the adhesive and the release liner.

In some embodiments, the adhesive may be formed according to step 810, deposited on the release liner according to step 820, and then the combined release liner and adhesive are contacted with the second major surface of the polymer film. In some embodiments, the adhesive material may be coated or casted on a release liner to be dried, and then cured and/or cooled to its tacky state. The adhesive is then laminated to the polymer film after the adhesive has dried, cured, and/or cooled to its tacky state. Such a lamination process may be used to avoid processing the high cost polymer film through a machine for adhesive coating.

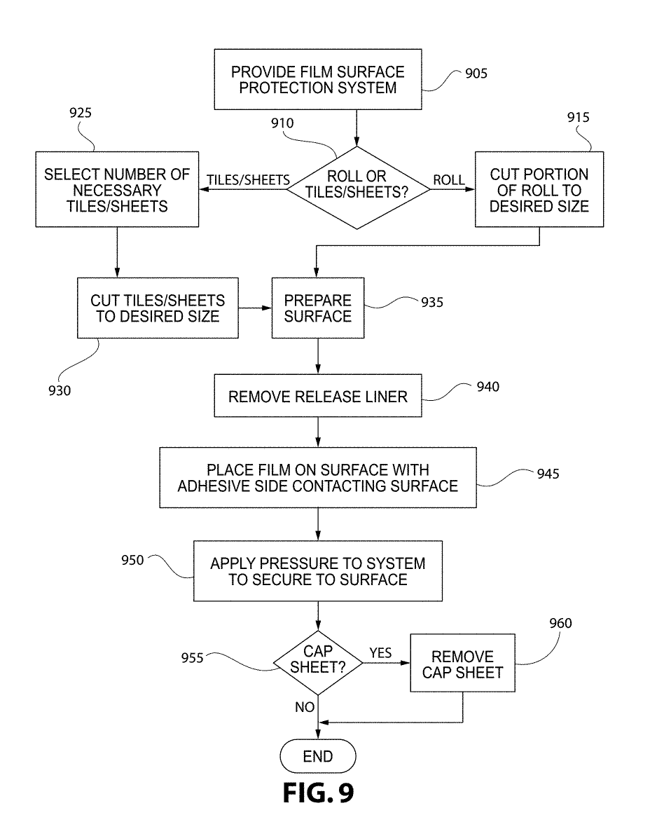

At step 825, a determination may optionally be made as to whether a cap sheet is to be included on the polymer film to protect the polymer film during manufacture or transport. If so, the cap sheet may be applied to the polymer film at step 830. If not, the process may proceed to step 835. It should be understood that, in some embodiments, the polymer film may be formed directly on the cap sheet as part of step 805, as described herein. It should further be understood that, in some embodiments, the cap sheet, if included, may subsequently be removed from the polymer film at any point during the steps described herein, including the steps described with respect to FIGS. 8 and 9.

Still referring to FIG. 8, at step 835, a determination as to whether the system is to be formed into rolls of material, tiles of material, or sheets of material may be made. If the system is to be formed into rolls, such rolls of film may be formed at step 840. The coating/casting process of the adhesive material and subsequent lamination of the adhesive to the polymer film as described herein may use a roll to roll formation process. Accordingly, such rolls may be manufactured during the coating/casting processes as described herein. However, in embodiments where smaller rolls are used, such smaller rolls can be achieved off-line using an industrial rewinder, slitter, and/or the like that are designed to handle the weight/size of the larger master rolls produced on the coating/casting equipment to generate smaller rolls.

If the system is to be formed into tiles, the tiles may be formed at step 845. Forming the tiles may include sectioning the various materials of the system into tile size portions. As such, the various materials may be cut, scored, perforated, and/or the like such that they exhibit various dimensional aspects, such as the dimensional aspects described herein. Forming tiles may be completed, for example via a sheeting process, such as by using a typical sheeting process whereby a master roll of film is slitted to a desired tile width. Once that roll has the desired width, the roll can be cut down to a desired length using an industrial sheeter.

If the system is to be formed into sheets, the sheets may be formed at step 850. Forming the sheets may include sectioning the various materials of the system into sheet size portions. As such, the various materials may be cut, scored, perforated, and/or the like such that they exhibit various dimensional aspects, such as the dimensional aspects described herein. Forming sheets may be completed, for example via a sheeting process, such as by using a typical sheeting process whereby a master roll of film is slitted to a desired sheet width. Once that roll has the desired width, the roll can be cut down to a desired length using an industrial sheeter. It should be understood that the difference between tiles and sheets as used herein are generally based on a particular size for various applications and application settings.

FIG. 9 depicts an illustrative method of applying the system to a surface. At step 905, the system is provided. That is, the fully formed system as described herein is provided. At step 910, a determination is made as to whether the system is in roll form or tile/sheet form. If in roll form, a portion of material may be selected from the roll and cut from the roll at step 915. That is, a user may measure the dimensional aspects of the surface upon which the system is to be applied, measure and mark the corresponding dimensional aspects on the system in the roll, and cut the roll accordingly. In some embodiments, the material may be pre-cut, perforated, or the like such that it can be separated from the roll by pulling the material along the perforations, cuts, or the like.

If in tile or sheet form, the number of tiles or sheets necessary to cover a particular surface area may be selected at step 925. The number of selected tiles or sheets may be based on the relative sizes of the surface to be protected and the tiles/sheets. In addition, a portion of material may be selected from the tiles/sheets and cut from the tiles/sheets at step 930. That is, a user may measure the dimensional aspects of the surface upon which the system is to be applied, measure and mark the corresponding dimensional aspects on the system in the various selected tiles or sheets, and cut the tiles or sheets accordingly. In some embodiments, the material may be pre-cut, perforated, or the like such that it can be separated easily by the user.

At step 935, the surface may be prepared. Preparation of the surface may include, for example, cleaning the surface, drying the surface, wetting the surface, applying a solvent to the surface, and/or the like. Surface preparation may be completed to ensure that no foreign materials are trapped between the surface and the polymer film (e.g., dirt, dust, etc.), or to ensure that the adhesive properly bonds the surface with the polymer film. In some embodiments, the surface may be wetted or sprayed with water and/or a cleaning solution. A clean, lint free cloth may be used to wipe the wall free of any dirt, oils, dust and other foreign particles. The surface may be allowed to dry for a period of at least 5 minutes.

At step 940, the release liner is removed to expose the adhesive. Removing the release liner may generally include peeling the release liner from the system and discarding the release liner. Once the release liner has been removed, at step 945, the polymer film is placed on the surface such that the second major surface of the polymer film (e.g., the surface containing the adhesive) is facing the surface so that the adhesive is sandwiched between the surface and the polymer film.

At step 950, pressure may be applied to the system to active the adhesive and cause the adhesive to bond the polymer film to the surface. Pressure may also be applied so as to remove any air bubbles that may be present between the polymer film and the surface. If the adhesive is not a pressure sensitive adhesive, other steps may also be included as a part of step 950. For example, heat may be applied to activate the adhesive and cause the adhesive to bond the polymer film to the surface.

At step 955, a determination may be made as to whether a cap sheet is located on the polymer film. If a cap sheet is on the polymer film, it may be removed at step 960 by peeling the cap sheet off If no cap sheet is included, the process may end. It should be understood that the cap sheet may be removed at any point during the steps described herein with respect to FIG. 9 and does not necessarily occur after the system is applied to the surface.

It should now be understood that the systems described herein provide damage protection for surfaces. The systems described herein generally include a polymer film with an adhesive backing that secures the polymer film to the surface without the need for mechanical retention components that damage the surface. In addition, the adhesive backing also allows the polymer film to be removed from the surface without damaging the surface.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A surface protection system comprising:
a damage resistant polyethylene terephthalate film comprising a first major surface and a second major surface, the damage resistant polyethylene terephthalate film having a thickness of about 8 mils to about 20 mils;
a hardcoat layer deposited on the first major surface of the damage resistant polyethylene terephthalate film;
a cap sheet contacting the hardcoat layer located on the first major surface of the damage resistant polyethylene terephthalate film;
an adhesive deposited on the second major surface the damage resistant polyethylene terephthalate film; and
a release liner covering the adhesive,
wherein the surface protection system, when applied to a surface, withstands damage at a pencil hardness of 4H or greater to protect the surface.

2. A surface protection system comprising:
a damage resistant polymer film comprising a major surface, the damage resistant polymer film having a thickness of about 8 mils to about 20 mils; and
an adhesive deposited on the major surface of the damage resistant polymer film.

3. The surface protection system of claim 2, wherein the damage resistant polymer film is opaque or partially opaque.

4. The surface protection system of claim 2, wherein the damage resistant polymer film is transparent.

5. The surface protection system of claim 2, wherein the damage resistant polymer film comprises one or more of polyethylene terephthalate, polyurethane, polyester, polyacrylic, and polycarbonate.

6. The surface protection system of claim 2, wherein the damage resistant polymer film is a polyethylene terephthalate film comprising a hard coat.

7. The surface protection system of claim 2, wherein the damage resistant polymer film comprises a monolayer of polymer material.

8. The surface protection system of claim 2, wherein the damage resistant polymer film comprises a plurality of layers of polymer material.

9. The surface protection system of claim 8, wherein the plurality of layers comprises a first layer constructed of a first polymer material and a second layer constructed of a second polymer material, wherein the first polymer material is different from the second polymer material.

10. The surface protection system of claim 2, wherein the damage resistant polymer film is embedded with one or more pigments.

11. The surface protection system of claim 2, wherein the damage resistant polymer film is embedded with one or more antimicrobial agents.

12. The surface protection system of claim 2, wherein the adhesive is a pressure sensitive adhesive.

13. The surface protection system of claim 2, wherein the adhesive has a thickness of about 0.5 mils to about 5 mils.

14. The surface protection system of claim 2, wherein the adhesive bonds the damage resistant polymer film to a surface.

15. The surface protection system of claim 2, further comprising a release liner disposed over the adhesive.

16. The surface protection system of claim 2, wherein the surface protection system is formed into one or more sheets, one or more tiles, or one or more rolls.

17. A surface protection system comprising:
a damage resistant polyethylene terephthalate film comprising a major surface, the damage resistant polyethylene terephthalate film having a thickness of about 8 mils to about 20 mils; and
an adhesive deposited on the major surface of the damage resistant polyacrylic film.

18. The surface protection system of claim 17, wherein the thickness of the damage resistant polyethylene terephthalate film is about 10 mils.

19. The surface protection system of claim 17, wherein the damage resistant polyethylene terephthalate film comprises a monolayer of polyethylene terephthalate material.

20. The surface protection system of claim 17, wherein the damage resistant polyethylene terephthalate film comprises a plurality of layers of polyethylene terephthalate material.
